(19) United States
(12) Patent Application Publication
(10) Pub. No.: US 2008/0236019 A1
(43) Pub. Date: Oct. 2, 2008

(54) Game fish disabling device, and method

(76) Inventor: Robert Gollahon, King George, VA (US)

Correspondence Address: KLIMA LAW OFFICES, P.L.L.C., P. O. Box 2855, Stafford, VA, 22555-2855, US

(21) Appl. No.: 11/730,062

(22) Filed: Mar. 29, 2007

(51) Int. Cl. A01K 97/00; A63B 15/00

(52) U.S. Cl. 43/4; 43/6; 463/47.2

(57) ABSTRACT

A game fish disabling device, and method of disabling a game fish. The game fish disabling device is preferably configured as a pole type device with a sliding “hammering” action to generate and transmit a disabling force or blow to the game fish, in particular the head of the game fish.

### FIELD OF THE INVENTION

The present invention is directed to a game fish disabling device, and method of disabling a game fish. Specifically, the game fish disabling device according to the present invention is used for stunning, knocking out, or otherwise disabling a game fish, for example, after fighting the game fish and then brought along side the game fishing boat and prior to being brought onboard thereof.

### BACKGROUND OF THE INVENTION

Currently, a variety of bats or clubs are used for hitting a game fish in the head after being brought alongside the game fishing boat. The mate hits the game fish in the head with a bat or club in an attempt to stun, or preferably knock out the game fish, in particularly a large game fish such as bill fish, sail fish, swordfish, tuna, and other large game fish in order to successfully retrieve the game fish from the water into the game fishing boat, and to prevent injury to the persons fishing and the crew. Specifically, large game fish especially game fish having a bill, are extremely dangerous, and can cause severe injury or death to persons on board the game fishing boat when such a fish is brought on board and not sufficiently disabled. The thrashing of the bill hitting a person can cause severe injury or death.

The use of bats or clubs by fishing mates to disable a game fish is somewhat difficult, in that the person using the bat or club must significantly bend and extend over the sidewall of the boat, and then attempt to hit the game fish in the head to disable same. Furthermore, this maneuver is extremely dangerous when fishing for bill fish, since such fish tend to rear upwardly and thrash with their bills possibly directly striking the person and causing severe injury or death. In addition, the bat or club can miss the fish and hit the boat and damage same, or cause injury to the user (e.g. bat or club bounces off boat and then hits user). Thus, there is a certain degree of skill required to successfully stun, knock out or otherwise disable the game fish, and always under dangerous conditions.

Thus, there is a need for a novel device and method that can be used to stun, knock out or otherwise disable a game fish, in particular in proximity to the game fishing boat, that greatly reduces the risk of injury or death to the user, and greatly increase the effectiveness of disabling the game fish.

### SUMMARY OF THE INVENTION

A first object of the present invention is to provide an improved game fish disabling device.

A second object of the present invention is to provide a contact type game fish disabling device, which enables the user to be able to direct the blow to the exact spot or the head of the fish.

A third object of the present invention is to provide a game fish disabling device actuated to make a disabling blow on the game fish after making initial contact of the game fish disabling device with the game fish.

A fourth object of the present invention is to provide a game fish disabling device configured to make contact with the head of the game fish prior to delivering a disabling blow to the game fish.

A fifth object of the present invention is to provide a pole type game fish disabling device.

A sixth object of the present invention is to provide a pole type game fish disabling device having a sliding arrangement to create a stunning or knock out blow or force to the game fish, in particular the head of the game fish.

A seventh object of the present invention is to provide a game fish disabling device having a “hammering” arrangement to generate a disabling blow to the game fish.

A eighth object of the present invention is to provide a game fish disabling device including a game fish contact tip combined with a sliding hammer arrangement to generate a disabling blow to the game fish.

A ninth object of the present invention is to provide a game fish disabling device with a sliding weighted hammer arrangement.

A tenth object of the present invention is to provide a method of disabling a game fish, including the steps of contacting the fish with a game fish disabling device, and then actuating the device to generate and deliver a stunning, knock out or otherwise disabling blow or force to the game fish, in particular to the head of the game fish.

A eleventh object of the present invention is to provide a method of disabling a game fish, including the steps of contacting the head of the game fish with a game fish disabling device, and then actuating the game fish disabling device having a sliding weighted hammer arrangement to generate and transmit a force to the head of the game fish.

A twelfth object of the present invention is to provide a method of disabling a game fish, including the steps of contacting the head of a game fish with a disabling tip of a game fish disabling device, and then actuated the device having a sliding hammer to generate a disabling blow or force, and transmit same through the disabling tip to the head of the game fish.

The present invention is directed to a game fish disabling device, method of disabling a game fish, in particular a method of disabling a game fish using the game fish disabling device according to the present invention.

The game fish disabling device according to the present invention has preferably a pole type arrangement or configuration. The length of the pole is preferably sufficient long enough to allow a user to stand on board the game fishing boat while holding the game fish disabling device, and making direct contact with the game fish using the end of the game fish disabling device while staying out of harm's way. Preferably, the end of the game fish disabling device is positioned to directly contact the head of the game fish to be disabled. The pole arrangement of the game fish disabling device is sufficiently long so that the game fish disabling device can be placed over the side of the game fishing boat and make contact with the game fish while maintaining the user at a safe distance and location from the game fish to be disabled.

A preferred embodiment of the game fish disabling device according to the present invention includes a first outer tube section and a second inner tube section slidably disposed within the first outer tube section. For example, the use of two different type metals or materials, such an aluminum tubing for the first outer tube section and stainless steal for the second inner tube section, prevents gaulding together caused by salt air and salt water. The outer tube section has one end closed and the other end opened to receive the inner tube section. The closed end of the outer tube section acts as a platen for the one end of the inner tube section, which acts as a hammer against the platen to provide a “hammering” configuration or arrangement to generate a stunning, knock out or otherwise disabling blow or force.

The closed end of the outer tube section is preferably provided with a disabling tip to make contact with the game fish, in particular with the bony flesh and head of the game fish. The disabling tip focuses or concentrates the disabling force generated by the “hammering” arrangement between the tube sections, and transmits and delivers the disabling blow or force into the bony head of the game fish to stun, knock out or otherwise disable the game fish. The disabling tip is somewhat pointed to allow accurate positioning and anchoring on the head of the game fish, and allows the “hammering” force to be transmitted through the disabling tip. The disabling tip can pierce into the bony flesh of the head of the game fish, however, the closed end of the outer tube section acts as a stop to prevent further ingress into the fish, and distributes the blow over a larger area of the head. Furthermore, the disabling tip is preferably somewhat blunt so as to not create a sharp tip that could damage, injure even cause death to fishing persons or crew, in particular during the typical excitement when a game fish is brought along side the fishing boat.

The inner tube section again is slideably disposed within the outer tube section. The inner tube section can have open ends to allow venting of air trapped within the outer tube section, and/or the outer tube can be provided with one or more vent holes, again to prevent air from being trapped and compressed within the outer tube during compression/expansion of the inner tube section within the outer tube section. In a preferred embodiment, the inner tube section is weighted to significantly increase the “hammering” force generated by the game fish disabling device. For example, the inner end of the inner tube section is closed, and then filled with a weight such as steel or lead metal. For example, the lead metal can be heated up and moltened, and then poured through an open outer end of the inner tube section and flow downwardly inside the inner tube section to the lower closed end when the inner tube section is oriented in a vertical position during manufacturing. Afterwards, the open outer end of the inner tube section, optionally, can also be closed to seal the inner tube section. Alternatively, a steel weight in a round rod-shaped configuration having an outer diameter slightly less than a inner diameter of the inner tube section can be slid into and down along the length of the inner tube section to the closed inner end, and then secured in place with one or more fasteners, (e.g. screws or rivets) through the wall thickness of inner tube section.

In a preferred embodiment, the outer tube section and the inner tube section are provided with hand grips or hand grip portions. For example, rubber, foam, plastic or other synthetic resilient material are formed (e.g. extruded, machined, molded), and then assembled onto the respective inner and outer tube sections. The handle grips increase the extent the tube sections can be gripped by a user during use. For example, the hand grips are injection-molded parts formed of a somewhat sticky and resilient foamed plastic or synthetic material, and then applied to the tube sections by use of interference fit, resilient force and/or adhesive. In a preferred embodiment, a hand strap is provided on the outer tube section to allow a user to grip the outer tube section through the handgrip to prevent the device from slipping out of the hands of the user. The hand strap provides an added measure of safety and gripping security, especially when the device is being used over the side of the game fishing boat.

The game fish disabling device according to the present invention is used by placing the device over the side of the game fishing boat, and then placing the end of the device having the disabling tip directly in contact with the game fish, in particular with the head of the game fish. The inner tube section is either already withdrawn, or can then be withdrawn from the outer tube section readied for generating and delivering a disabling blow or force. Specifically, with the inner tube section retracted from the outer tube section, the user with one hand grips the outer tube section and with the other hand forces the inner tube section into the outer tube section until the inner end of the inner tube section bottoms out and hammers the inner surface of the closed end of the outer tube section generating a “hammering” force, which is then transmitted along the disabling tip into the fish to deliver a disabling blow. The user can again retract the inner tube section from the outer tube section to provide one or more additional blows repeatedly to the game fish until the game fish is sufficiently disabled to be brought onboard the fishing boat.

The game fish disabling method according to the present invention includes the steps of contacting the game fish, in particular the head of the game fish, with a game fish disabling device, and then generating and transmitting a disabling blow or force from the device to the game fish. The step of contacting the game fish, in particular the head of the game fish, with the game fish disabling device prior to generating and transmitting a disabling force greatly increases the safety and efficiency of disabling a game fish versus the old conventional devices and methods discussed above in the background of the invention. Specifically, the contacting and maintaining contact of the game fish disabling device with the game fish prior to generation and transmitting of the disabling force to the game fish ensures that the disabling blow or force is direct transmitted accurately, efficiently, and effectively to the game fish. This method eliminates the skill necessary to aim the device and successfully hit the game fish at the right location as required by the old conventional bats or clubs. The pole arrangement of a preferred embodiment of the game fish disabling device according to the present invention allows the disabling tip to be accurately located at the right location, and then maintained in contact with the game fish during the step of generating and transmitting the disabling force to the game fish. Specifically, the somewhat blunt tip of the disabling tip is easily maintained in contact with the game fish after the initial contact when maintaining slight pressure while the user is getting ready to generate and transmit the disabling blow or force to the game fish. Even if the game fish moves around, the disabling tip can be somewhat anchored and maintained in contact with the game fish while the user is getting ready to deliver the disabling blow.

### BRIEF DESCRIPTION OF THE DRAWINGS

FIG. 1 is a perspective view of a preferred embodiment of the game fish disabling device according to the present invention.

FIG. 2 is a side elevational view of the game fish disabling device shown in FIG. 1.

FIG. 3 is a partial broken away center vertical longitudinal cross-sectional view of the game fish disabling device shown in FIG. 2.

FIG. 4 is a detailed broken away center vertical cross-sectional view of the disabling tip shown mechanically connected to the end plate of the outer tube section.

FIG. 5 is a detailed broken away center vertical cross-sectional view showing the “hammering” contact between the inner end of the inner tube section and the closed end of the outer tube section.

FIG. 6 is a perspective view of the game fish disabling device, as shown in FIG. 1, in operation and in contact with a game fish about to be disabled along the side of a fishing boat.

### DETAILED DESCRIPTION OF PREFERRED EMBODIMENTS

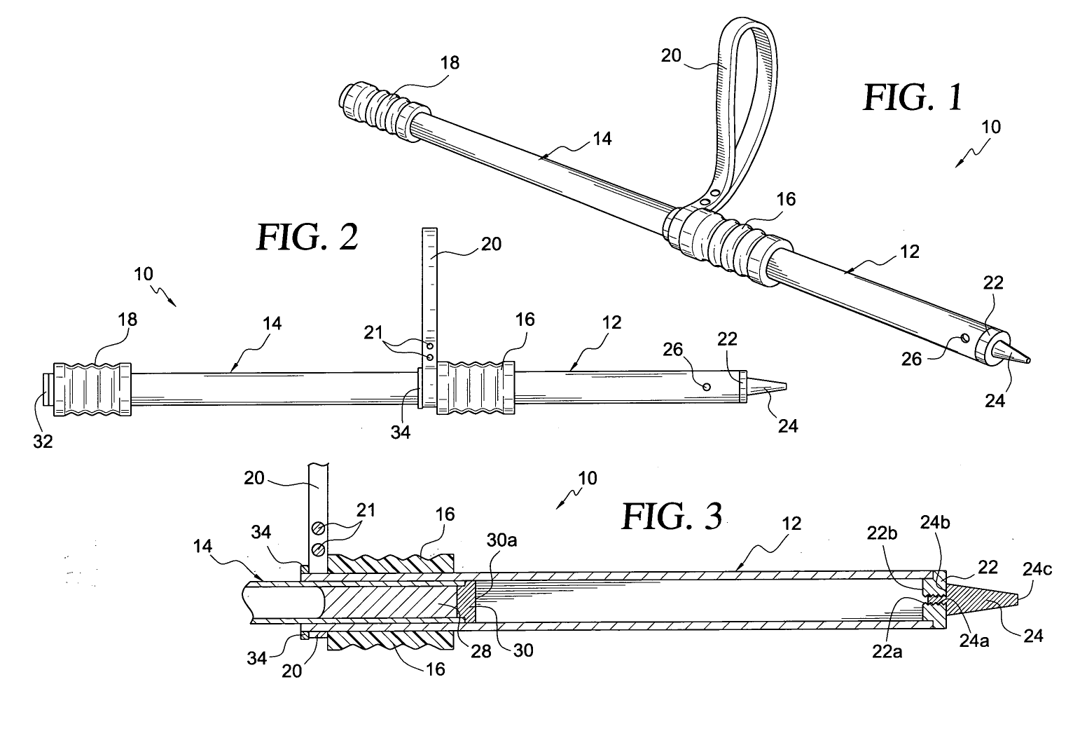

A preferred embodiment of the game fish disabling device 10 according to the present invention is shown in FIGS. 1-5.

The game fish disabling device 10 has a pole type configuration provided by an outer tube section 12 connected to an inner tube section 14. The inner tube section 14 is slidably disposed within the outer tube section 12. The inner tube section 14 can be set up to be removable from the outer tube section 12, or can be provided with a stop arrangement so as to prevent the inner tube section 14 from being completely removed from the outer tube section 12 after assembly and during use or storage.

The outer tube section 12 and inner tube section 14 can be made of metal, aluminum, titanium, steel, plastic, ABS, polyvinyl chloride (PVC), fiber glass, composite, Keviar, graphite, carbon, or other suitable known material. In the preferred embodiment of the game fish disabling device 10 shown in FIGS. 1-5, the outer tube section 12 and inner tube section 14 are made of an aluminum alloy and/or stainless steel to facilitate the construction thereof.

Again, the inner tube section 14 is slidably disposed within the outer tube section 12. The outer tube section 12 and the inner tube section 14 can be cut from stock aluminum alloy tubing or stainless steel to the desired length for a particular design or application. Alternatively, the inner tube section 14 can be replaced with a solid aluminum rod section. Preferably, the outer diameter of the inner tube section 14 is slightly less than the inner diameter of the outer tube section 12 to provide a close freely sliding connection therebetween while providing adequate structural strength (e.g. against bending) along the entire length of the pole type configuration of the game fish disabling device 10.

The outer tube section 12 is provided with a handgrip portion 16, and the inner tube section 14 is provided with a handgrip portion 18. The hand grip portions 16, 18 can be made of metal, cloth, tape, rubber, synthetic rubber, composite, Kevlar, graphite, plastic, synthetic resin or other suitable known material. Preferably, the handgrip portion 16, 18 are injection-molded parts made from a soft, somewhat sticky, and resilient synthetic plastic resin, or soft resilient foam material. The hand grip portions 16, 18 can be made as a unitary structure with the tube structure (e.g. spun, extruded, machined from aluminum billet), or can be made as separate pieces, and then assembled onto the outer tube section 12 and inner tube section 14. For example, the handgrip portions 16, 18 are made from extruded or injection molded synthetic resin material, and then assembled onto the outer tube section 12 and inner tube section 14. The inner diameters of the handgrip portions 16, 18 can be made slightly less than the respective outer diameters of the outer tube section 12 and the inner tube section 14 to provide a resilient interference fit thereon. Alternatively, or in addition, adhesive is utilized to adhere the handgrip portions 16, 18, respectively to the outer tube section 12 and inner tube section 14 and/or mechanical fasteners are utilized.

A hand strap 20 is provided on the outer tube section 12 to provide an added or secondary back up grip on the game fish disabling device 10 for use with one of the user's wrists. This configuration allows the user to still hold onto the game fish disabling device 10 in the event the user looses his or her grip on the hand grip portion 16 during handling or use thereof. The hand strap 20 can be made of leather, cloth, plastic, strapping, composite, vinyl or other suitable known material.

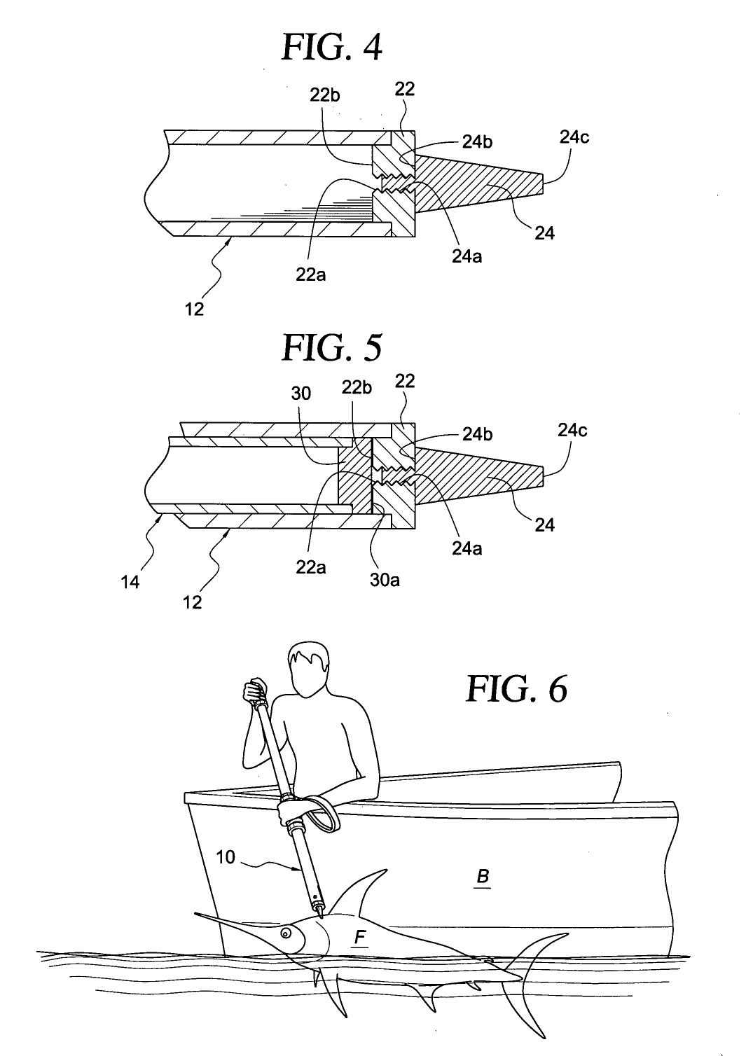

The outer tube section 12 is provided with an end plate or cap 22 to provide a closed end of the outer tube section 12. The opposite end of the outer tube section 12 is opened to accommodate the slidable inner tube section 14. For example, the end plate 22 can be made from a circular-shaped piece of aluminum plate, and mechanically fastened and/or welded to the end of the outer tube section 12. A game fish disabling tip 24 is connected to the end plate 22. For example, the disabling tip 24 is provided with a threaded male extension 24a that threadedly connects with a threaded female through hole 22a provided in the end plate 22, as shown in detail in FIG. 4. The threaded male extension 24a has a smaller outer diameter relative to the base of the disabling tip 24 to provide a flange 24, which flange 24b provides a stop when disabling tip 24 is fully screwed into the end plate 22. The disabling tip 24 is provided with a free end 24c having a substantially blunt shaped end face. The blunt end 24c prevents the disabling tip 24 from puncturing too deep into the flesh and/or bone of the game fish, in particular the bony flesh of the head of the game fish. Furthermore, the blunt end 24c prevents inadvertent injury to the fishermen and crew during storage and use of the game fish disabling device 10.

The outer tube section 12 is provided with a vent hole 26 provided through the wall thickness of the outer tube section 12 to allow air to escape in and out of the inner volume of the outer tube section 12 when the inner tube section 14 is inserted or withdrawn, respectively, from the outer tube section 12. Alternatively, air vent(s), hole(s) or passageway(s) can be provided through the length of the inner tube section 14 to allow air to escape in and out of the outer tube section 12. In an alternative embodiment, a one-way valve is provided in the vent hole 26 to allow air to either escape inwardly or outwardly from the outer tube section 12. In this manner the air trapped within the outer tube section 12 can be used as an expandable or retractable spring to end of the inner tube section 14 is provided with an air seal, and the air vent 26 is provided with a one-way valve oriented so that the air inside the outer tube section 12 is expanded when the inner tube section 14 is withdrawn from the outer tube section 12. A latch (not shown) is provided to keep the inner tube section 14 fully retracted from the outer tube section 12, and a release (e.g. push button) is utilized to release the latch and allow the inner tube section 14 to forcibly retract into the outer tube section 12 to provide the “hammering” action when the inner end of the inner tube section 14 makes contact with the closed end of the outer tube section 12. As a further alternative example, a one way valve is inserted in the air vent 26 and oriented so that air is trapped within the outer tube section 12 when the inner tube section 14 is forced inwardly, and then the air trapped inside the outer tube section acts as an air spring to automatically withdraw the inner tube section 14 after “hammering” contact between the inner end of the inner tube section 14 and the closed end of the outer tube section 12. However, the most simple and reliable embodiment utilizes an open air vent 26 to allow the air to escape inwardly and outwardly freely from the interior volume of the outer tube section 12.

In a preferred design or version of the game fish disabling device 10, optionally, the inner tube section 14 is weighted to increase the mass of the inner tube section 14 to provide an increased “hammering” force when contact is made between the inner end of the inner tube section 14 with the closed end of the outer tube section 12. For example, added weight 28 is provided in the inner end of the inner tube section 14, as shown in FIG. 3, provided by pouring molten lead metal into an outer open end of the inner tube section 14 and then flowing down into the inner end of the inner tube section 14 provided with an end plate or cap 30 during the manufacturing of the inner tube section 14. The end plate 30 is mechanically fastened and/or welded to the inner end of the inner tube section 14, and the inner tube section 14 is then oriented vertically to allow the molten lead metal material to flow downwardly from the open end of the inner tube section 14 to the closed inner end of the inner tube section 14. Optionally, the open outer end of the inner tube section 14 is provided with an end plate or cap 32 to seal the inner volume of the inner tube section 14, for example, to prevent interior corrosion thereof. Alternatively, the inner tube section 14 can be weighted by a separate weight, for example, a rod of lead or steel material welded, adhered, and/or mechanically fastened within the inner tube section 14.

A ring-shaped retainer flange 34 is provided adjacent the open end of the outer tube section 12 to retain the hand strap 20 wrapped around the outer circumference of the outer tube section 12 from disconnecting with the outer tube section 12 during use. Specifically, the portion of the hand strap 20 wrapped around the outer circumference adjacent the open end of the outer tube section 12, and riveted in place with rivets 21. The hand strap 20 is then trapped between the ring-shaped retainer flange 34 and the handgrip portion 16.

During use, the game fish disabling device 10 is held over the side of the fishing boat B and the user then places the disabling tip 24 into direct contact with the game fish, preferably the head of the game fish. The user retracts the inner tube section 14 substantially fully from the outer tube section 12 using the handgrip portion 18, and while securely holding the outer tube section 12 with the handgrip portion 16 using the other hand, forces the inner tube section 14 downwardly into “hammering” contact with the closed end of the outer tube section 12, as shown in FIG. 5. Specifically, the inner end of the inner tube section 14 makes “hammering” contact with the closed end of the outer tube section 12. More specifically, the end plate 30 of the inner tube section 14 makes contact with the end plate 22 of the outer tube section 12 causing a “hammering” action generating a disabling force that is transmitted through the end plate 22, disabling tip 24, and then into the game fish, in particular the head of the game fish. This creates a substantial disabling blow to the head of the game fish stunning, knocking out or otherwise disabling the game fish. In some cases, repeated blows with the game fish disabling device 10 are made on the game fish by repeatedly inserting and withdrawing the inner tube section 14 into “hammering” contact with the closed end of the outer tube section 12. In this manner, the inner surface 22b of the end plate 22 acts a platen for the outer surface 30a of the end plate 30 of the inner tube section 14 acting as a hammer face against the inner surface 22b of the end plate 22. The weighted inner end of the inner tube section 14 substantially increases the “hammering” action to generate a larger disabling force, which is then transmitted through the disabling tip 24 into the game fish.

The method of disabling a game fish according to the present invention, includes the step of making contact, preferably direct contact, with the game fish in particular the head of the game fish, and then generating and transmitting a force, in particular a “hammering” force into the game fish. The delivery of a disabling blow after the initial contact with the game fish itself significantly increases the effectiveness and safety of use of the game fish disabling device. Repeated blows can be applied to further stun, knock out or otherwise disable the game fish to an extent that is suitable to allow the game fish to be safely brought on board the fishing boat.

I claim:

1. A fish disabling device, said device comprising:
a first aluminum tubular shaft provided with a separate resilient first hand grip portion, said first shaft having an open end and opposite closed end fitted with a welded aluminum end plate;
a steel fish disabling tip having a male threaded portion threaded into a female threaded hole provided in said welded aluminum end plate of said first shaft;
a second tubular shaft having an accessible first end and a second end slidably disposed within said first shaft, said second shaft being longer than said first shaft and extending out of said open end of said first shaft, said second shaft having at one end an exposed closed and welded aluminum end plate and at an opposite end a sliding closed and welded aluminum end plate slidably disposed within said first shaft, said accessible end of said second shaft being provided with a separate resilient second hand grip portion;
a stop associated with said device to prevent said second shaft from being fully withdrawn from said first shaft; and
a lead weight disposed within said second shaft and in contact with said sliding closed and welded aluminum end plate, whereby a user maneuvers said fish disabling device to place said fish disabling tip in contact with a head of the fish in the water to be disabled, and then with one hand forces said second shaft, initially extending substantially fully out of said first shaft, into said first shaft while holding said first shaft stationary with the other hand so that said weighted end of said second shaft hammers said closed welded end plate of said first shaft transferring and concentrating the resulting hammering force to said fish disabling tip, which hammering force is then transferred to the head of the fish to disable same.

2. A fish disabling device, said device comprising:
a first tubular shaft provided with a first handgrip portion, said first shaft having an open end and opposite closed end;
a fish disabling tip male threaded into a female threaded hole provided in said closed end of said first shaft;
a second tubular shaft having an accessible first end and a second end slidably disposed within said first shaft, said second shaft being longer than said first shaft and extending out of said open end of said first shaft, said second shaft having a first exposed closed end and a second sliding closed end slidably disposed within said first shaft, said accessible end of said second shaft being provided with a second hand grip portion;
a stop associated with said device to prevent said second shaft being fully withdrawn from said first shaft; and
a weight disposed within said second shaft and in contact with said second sliding closed end, whereby a user maneuvers said fish disabling device to place said fish disabling tip in contact with a fish to be disabled, and then with one hand forces said second shaft, initially extending out of said first shaft, into said first shaft while holding said first shaft stationary with the other hand so that said weighted end of said second shaft hammers said closed end of said first shaft transferring and concentrating the resulting hammering force to said fish disabling tip, which hammering force is then transferred to the fish to disable same.

3. A fish disabling device, said device comprising:
a first tubular shaft having an open end and opposite closed end;
a fish disabling tip connected to said closed end of said first shaft; and
a second shaft having an accessible first end and a second end slidably disposed within said first shaft, said second shaft being longer than said first shaft and extending out of said open end of said first shaft, said second shaft being weighted, whereby a user maneuvers said fish disabling device to place said fish disabling tip in contact with a fish to be disabled, and then with one hand forces said second shaft, initially extending out of said first shaft, into said first shaft while holding said first shaft stationary with the other hand so that said weighted second shaft hammers said closed end of said first shaft transferring and concentrating the resulting hammering force to said fish disabling tip, which hammering force is then transferred to the fish to disable same.

4. A device according to claim 1, wherein said first shaft is provided with a hand strap.

5. A device according to claim 1, wherein said device is provided with a vent to release air trapped in said first shaft.

6. A device according to claim 5, wherein said vent is provided in said first shaft.

7. A device according to claim 6, wherein said vent is defined by a through hole provided in a wall of said first shaft.

8. A device according to claim 5, wherein said vent is provided in said second shaft.

9. A device according to claim 8, wherein said vent is defined by respective through holes provided in said end plates of said second shaft.

10. A device according to claim 1, wherein said lead weight is provided by melting lead metal, and then pouring said melted lead into said second shaft oriented in a substantially vertical position, prior to said end plate being welded onto said accessible end of said second shaft, and then allowing gravity to carry said melted weight into contact with said sliding closed and welded end plate previously installed, and then allowing the lead to cool and harden in place in contact with an inner surface of said sliding end plate within said second shaft.

11. A device according to claim 1, wherein said fish disabling tip tapers downwardly from a base portion to a tip portion.

12. A device according to claim 1, wherein said fish disabling tip has a blunt end portion.

13. A device according to claim 11, wherein said fish disabling tip has a blunt end portion.

14. A device according to claim 11, wherein said male threaded portion of said fish disabling tip extends outwardly from said base portion so that said base portion acts as a stop when fully tightened within said female threaded hole provided in said welded aluminum end plate of said first shaft.

15. A device according to claim 1, wherein said welded aluminum end plate of said first shaft includes a plate portion and flange cooperating with the end face and inner surface of said first shaft when assembled.

16. A device according to claim 3, wherein said second shaft is a weighted tubular shaft.

17. A device according to claim 16, wherein said second shaft is weighted with lead metal.

18. A device according to claim 16, wherein said second shaft is weighted with steel.

19. A device according to claim 3, including a stop associated with said device to prevent said second shaft from being fully withdrawn from said first shaft.

20. A method of disabling a game fish, comprising the steps of:
directly contacting a head of a game fish with a game fish disabling device; and
then generating and transmitting a disabling blow from the game fish disabling device to the game fish.
